(19) United States
(12) Patent Application Publication
(10) Pub. No.: US 2010/0014076 A1
(43) Pub. Date: Jan. 21, 2010

(54) Spectrometric apparatus for measuring shifted spectral distributions

(76) Inventors: Morten Henneberg, Odense (DK); Stefan Ovesen Banke, Odense (DK)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/921,737

(22) PCT Filed: Jun. 8, 2006
(86) PCT No.: PCT/DK2006/000319

§ 371 Date: Sep. 28, 2009

(30) Foreign Application Priority Data
Jun. 9, 2005 (DK) PA 2005 00840

(51) Int. Cl. G01J 3/44

(52) U.S. Cl. 356/301

(57) ABSTRACT

This invention relates to a spectroscopic apparatus for measuring at least two spectrally shifted spectral distributions of a light beam, said apparatus comprises a dispersive element adapted to generate a spatial dispersion of the spectral components in a light beam when said dispersive element is being illuminated by said light beam; and a detector adapted to measure the intensity of at least a part of said dispersed spectral components where said apparatus further comprises an optical shifting means adapted to illuminate said dispersive element in at least two different ways, such that said light beam hits said dispersive element differently, and whereby said dispersive element generates at least two spatially shifted spatial dispersions of the spectral components in said light beam. The invention further relates to a probing system comprising said spectroscopic apparatus for measuring at least two spectrally shifted spectral distributions of a light beam, and a method for measuring at least two spectrally shifted spectral distributions of a light beam.

### FIELD OF THE INVENTION

This invention relates to a spectroscopic apparatus. It finds applications in the optical spectroscopic instruments wherein light beams are analyzed against its spectral components for instance in absorption, diffusion, Raman, fluorescence, phosphorescence and transmission studies. The present invention especially relates to and finds application within the area of Shifted Subtracted Raman Spectroscopy (SSRS-method).

### BACKGROUND

Spectroscopy is a method for obtaining information on a molecular scale by the use of light. This information can be the rotational, vibration and electronic states of the molecules probed as well as dissociation energy and more. This information could e.g. be used to analyze a sample comprising a number of unknown molecular components and thereby get knowledge about the molecular components of the sample.

The basis setup in spectroscopy is a light source used for illumination of the molecular sample. The light from the light source would interact with the sample, and the result of the interaction would typically be altered light that is transmitted, reflected or scattered through/by the sample. The spectral distribution of the altered light is thereafter measured in order to analyze the changes in the light due to the interaction between the light from the light source and the molecular sample.

This measurement of the spectral distribution is typically done by using a spectrometer. A spectrometer is an optical apparatus that works by separating an incoming light beam into different wavelength segments. The spectral distribution is thereafter obtained by measuring the intensity of the different wavelength segments.

A spectrometer typically comprises an entry slit where the light enters the spectrometer, optical component(s) such as mirrors, lenses, diffraction gratings, filters and detectors. The spectrometer is typically constructed such that the entry slit is imaged onto a detector. This is achieved by arranging mirrors and lenses such that the slit would be imaged onto the detector. Furthermore, a diffracting grating is inserted in the optical path in order to split the light into wavelength segments. One possible spectrometer setup that is widely used is known as the Chezney-Turner setup which comprises an entrance slit that is reflected on a parabolic mirror. The reflection then hits a diffraction grating and another parabolic mirror before being imaged onto an electronic detector formed as a CCD-array. The grating is the diffracting optical element that disperses light having entered the spectrometer into monochromatic segments to be imaged on different pixels at the CCD-array.

Raman spectroscopy in particular is the study of the scattered light when this interacts with molecules. These molecules may be in a gas, liquid or solid state. The scattering can be elastic, Rayleigh scattering, for which there is no frequency shift in the scattered light compared with the incoming light, or inelastic, Raman scattering, for which there is an energy interchanging between the molecule and the photons. The inelastic scattering can excite the rotational, vibrational or electronic energy state of the molecule and thereby change the frequency (spectral distribution) of the scattered light. Since only certain transitions are allowable for each molecule, this results in unique Raman lines in the spectral distribution for each molecule. This can be used for identification of the molecular composition of the substance probed and/or the concentration of the specific molecule in the substance.

The Raman scattering is a weak effect compared to other spectroscopic methods and effects such as Rayleigh scattering, fluorescence and phosphorescence. This makes the identification and differentiation of the Raman lines in the spectral distribution problematic, especially if the scattered light signal also is dominated by for instance fluorescence.

The Shifted Subtracted Raman Spectroscopi (SSRS) method is a technique that can remove the fluorescence from the Raman signal. The original method uses two lasers with a small difference in wavelength as the light sources. Two spectral distributions (one with both lasers) are obtained from the sample with use of a spectrometer, and the obtained spectra include both the Raman signal and fluorescence. Due to the wavelength difference between the lasers, the Raman signal is shifted a small spectral distance whereas the fluorescence is not shifted. These two spectra are then subtracted. The subtracted spectra are then correlated with a reference function for identification of the Raman signal lines. After the identification of the Raman signal the spectra are reconstructed and the Raman signal is now displayed without fluorescence.

The SSRS method has been proven to work by using one light source laser; however, it is then necessary to change the internal dispersion angle of the diffraction grating inside the spectrometer in order to obtain two shifted Raman signals. This is in the present Raman spectrometer equipment obtained by rotating the diffraction grating using mechanical means and thereby shift the positions of the wavelength segments imaged onto the detector.

The Raman spectrometer equipment available today is inadequate for implementing the SSRS method using one light source, especially when the SSRS method is used in connection with analyses of samples. This is due to the fact that the diffraction grating is rotated by mechanical means. The mechanical tolerances make it difficult (or even impossible) to construct/choose a proper reference function used for the SSRS method and the result is that the SSRS method cannot be implemented successfully. The reference function must match the spectral shift on the detector in order to optimize the correlation and recognition of the shifted Raman lines. If the shift is dependent on movable parts (such as a rotating grating), the shift is not uniform and efficiency is lost. Furthermore, if the obtained spectra for use in the SSRS method are not done on the same pixel array/CCD, the difference in pixel efficiency and readout noise makes the SSRS method less functional.

Furthermore, the reflecting grating disperses the light according to the incident angle of the slit. This means that a relative small angle modification gives rise to a large spectral shift on the detector, and this is a problem since only a small spectral shift is wanted and the slits must have a certain physical distance due to their dimensions.

### OBJECT AND SUMMARY OF THE INVENTION

The object of the present invention is to solve the above described problems.

This is achieved by a spectroscopic apparatus for measuring at least two spectrally shifted spectral distributions of a light beam, said apparatus comprises a dispersive element adapted to generate a spatial dispersion of the spectral components in a light beam when said dispersive element is being illuminated by said light beam; and a detector adapted to measure the intensity of at least a part of said dispersed spectral components, where said apparatus further comprises optical shifting means adapted to illuminate said dispersive element in at least two different ways whereby said dispersive element generates at least two spatially shifted spatial dispersions of the spectral components in said light beam.

Hereby it is possible to measure two spectrally shifted spectral distributions of the same light beam. The optical shifting means is adapted to illuminate the dispersive element in different ways such that at least two spatially shifted spatial dispersions of the spectral components in the light beam are generated by the dispersive element. The dispersive element could for instance be any kind of diffraction grating, and the optical shifting means could for instance be constructed by optical components such as apertures, slits, prisms, mirrors, lenses, optical fibres or the like. The optical shifting means is adapted to receive the light beam and direct it towards the dispersive element in different ways such that the dispersive element at one time could be illuminated by said light beam in a first way and at another time in a second way. The dispersive element would therefore generate a first and a second spatially shifted spatial dispersion of the spectral components in the light beam. The intensity of the spectral components from the first spatial distribution could then be measured by a detector—for instance a CCD-detector comprising a number of photo detectors where the photo detectors measure different spectral components. The intensity of the spectral components from the second spatial distribution could thereafter be measured by the same CCD-detector. The CCD-detector would therefore be able to detect two spectrally shifted spectral distributions on the light beam. Hereby it is achieved that a very precise shift in the spatial distribution could be generated without rotating the dispersive element. Furthermore, the same CCD-detector could be used to detect the two spectrally shifted spectral distributions of the same light beam, whereby it is possible to take the difference in pixel efficiency and readout noise into account when measuring the two spectrally shifted spectral distributions. The consequence is that the two spectrally shifted spectral distributions of the same light beam could be used in an optimised SSRS method in order to reduce fluorescence in Raman spectra, since the spectra could be constructed very precisely.

In another embodiment of the spectroscopic apparatus the optical shifting means comprises an optical switch, a first optical path and a second optical path, where said optical switch is adapted to receive said light beam and adapted to direct said light beam into said first optical path or into said second optical path, said first optical path being adapted to illuminate said dispersive element in a first way whereby said dispersive element generates a first spatial dispersion of the spectral components in said light beam and said second optical path being adapted to illuminate said dispersive element in a second way, whereby said dispersive element generates a second spatial dispersion of the spectral components in said light beam being spatially shifted compared to said first dispersion. The optical switch could for instance be a crystal adapted to revive the light beam and to direct the light beam into different directions when different electrical powers are applied across the crystal. The crystal could therefore be adapted to direct the light beam into a first optical path or into a second optical path. An optical path defines the path along which a light beam would propagate in an optical system. An optical path could for instance be an optical fibre where a light beam propagates inside the core due to internal reflections, or an optical path could be created by a number of mirrors that direct a light beam from one point to another point, etc. Therefore it is achieved that it is possible to direct the light beam into a first optical path and thereby illuminate the dispersive element in a first way and thereafter direct the light beam into a second optical path and thereby illuminate the dispersive element in a second way. The result is that it is possible to design how the dispersive element is illuminated in the first and second way, and the spectral shift could therefore be designed very precisely by a person skilled in the art.

In an further embodiment of the spectroscopic apparatus, the first optical path comprises a first slit illuminated by said light beam, a first collimation means receiving said light beam from said first slit, where said first collimation means is adapted to collimate said light beam such that said dispersive element in said first way is illuminated by a first collimated light beam. Hereby it is possible to design the first optical path so that the dispersive element is illuminated by a collimated light beam which results in a uniform spatial distribution of the first spatial distribution.

In an further embodiment of the spectroscopic apparatus, the second optical path comprises a second slit illuminated by said light beam, a second collimation means receiving said light beam from said second slit, where said second collimation means is adapted to collimate said light beam such that said dispersive element in said second way is illuminated by a second collimated light beam. Hereby it is possible to design the second optical path so that the dispersive element is illuminated by a collimated light beam which results in a uniform spatial distribution of the second spatial distribution.

In a further embodiment the spectroscopic apparatus further comprises focusing means adapted to focus at least a part of said at least two spatially shifted spatial dispersions onto said detector. Hereby it is possible to design the apparatus such that the detector would collect as much light as possible.

In a further embodiment of the spectroscopic apparatus, the detector is a detector comprising a number of photo detectors. Hereby it is achieved that the intensity of spectral components of the light beam could be measured very fast and precisely.

In a further embodiment of the spectroscopic apparatus, the focusing means further is adapted to focus said at least a part of said two spatially shifted spatial dispersions onto a number of said photo detectors such that each photo detector is illuminated by different spectral components when said dispersive element is illuminated in different ways. Hereby an image of the first and second slit could be imaged onto each photo detector such that each photo detector would detect the intensity of predetermined spectral components of said light beam. Furthermore, the spectral shift could be designed very precisely.

The present invention further relates to a probing system for analysis of a light beam collected from a sample where the probing system comprises a spectroscopic apparatus as described above. Hereby is possible to analyse the spectral components of the light beam by measuring two spectrally shifted spectral distributions of the spectral components of the light beam. This could for instance be a Raman signal received from the sample.

In further embodiments the probing system further comprises a light source for illumination of said sample; an optical probe adapted to collect the light beam from said sample and adapted to direct said light beam into said spectroscopic apparatus and/or processing means and storing means, said processing being adapted to store spectrally shifted spectral distributions measured by said spectroscopic apparatus in said storing means. Hereby the above advantages are obtained, and the probing system could further be designed to illuminate the sample and thereafter collect the light beam after the light from the light source has interacted with the sample.

In a further embodiment of the probing system, the processing means are further adapted to perform an SSRS method using the spectrally shifted spectral distributions. Hereby the probing system could be adapted to automatically perform the SSRS method using the spectrally shifted spectral distributions. Hereby it is possible to remove florescent from Raman spectra and at the same time enhance the Raman lines. The consequence is that Raman spectroscopy could be used to analyze the molecular components in a sample.

The method further relates to a method for measuring at least two spectrally shifted spectral distributions of a light beam; said method comprises the step of generating a first spatial dispersion of the spectral components in said light beam by illuminating a dispersive element by said light beam in a first way, such that said dispersive element generates a first spatial dispersion of the spectral components in said light beam; the step of detecting the intensity of at least a part of said first spatial dispersion using a detector, and the step of generating a second spatial dispersion of the spectral components in said light beam by illuminating said dispersive element by said light beam in a second way, such that said dispersive element generates a second spatial dispersion of the spectral components in said light beam being spatially shifted compared to said first dispersion; and the step of detecting the intensity of at least a part of said second spatial dispersion using said detector. Hereby the above describe advantages are achieved.

### BRIEF DESCRIPTION OF THE DRAWINGS

In the following, preferred embodiments of the invention will be described referring to the figures, where

FIG. 1 illustrates a Czerny-Turner spectrometer.

FIG. 2 illustrates a flow diagram of the SSRS method

FIG. 3 illustrates an embodiment of the present invention.

FIG. 4 illustrates a second embodiment of the present invention.

FIG. 5 illustrates a third embodiment of the present invention.

### DESCRIPTION OF PREFERRED EMBODIMENTS

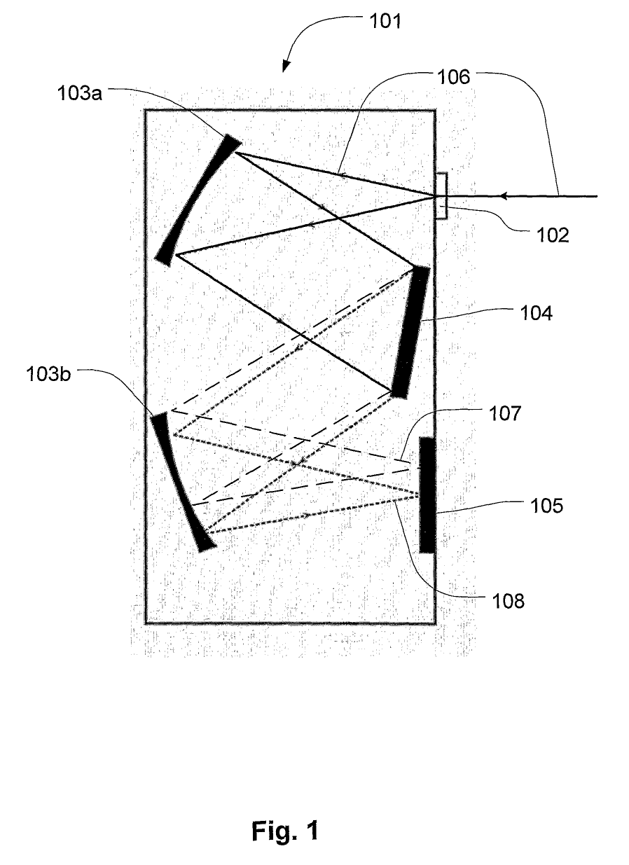

FIG. 1 illustrates the principles of spectroscopy and shows a spectrometer (101) constructed on the basis of a Czerny-Turner spectrometer. The spectrometer comprises an entry slit (102), a first (103a) and second (103b) concave mirror, a reflection grating (104) and a CCD detector (105). The light beam (106) enters the spectrometer at the entry slit and is thereafter directed to a first concave mirror (103a) which collimates and redirects the light beam onto the reflection grating (104). The reflection grating disperses the light into different wavelengths and redirects the light to the second concave mirror (103b) which focuses the light onto the CCD detector. The different wavelengths would be focused different places on the CCD due to the dispersion at the grating. This is illustrated in the figure by showing two different wavelengths drawn in a dashed (107) and a dotted (108) line. The CCD detector comprises a number of individual photo detectors lined up in an array, and each photo detector would therefore detect the intensity of the wavelength segment that is focused on to the photo detector. This setup makes it possible to measure the spectral distribution of the light beam (106) very fast because the CCD could register the intensity measured by each photo detector approximately at the same time. Most spectrometers are therefore constructed so that the CCD is illuminated by the wavelength spectrum of which the spectral distribution needs to be measured. The resolution of the spectral distribution is dependent on how wide a spectrum the CCD needs to cover and the amount of individual photo detectors present in the array.

The above described spectrometer could be used to measure two shifted spectral distributions of the same test beam (106) in order to use the SSRS method to reduce fluorescence and enhance the Raman lines in a Raman spectre. In the present spectrometer this could for instance be done by rotating the refraction grating, and the result is that the wavelength segments would be moved on the CCD array, and the same wavelength would thus be detected by another photo diode in the CCD array. Thereby it is possible to obtain two shifted spectra of the test beam. However, there are a number of disadvantages as described above when traditional spectrometers like this is used for obtaining Raman spectra to be used in the SSRS method.

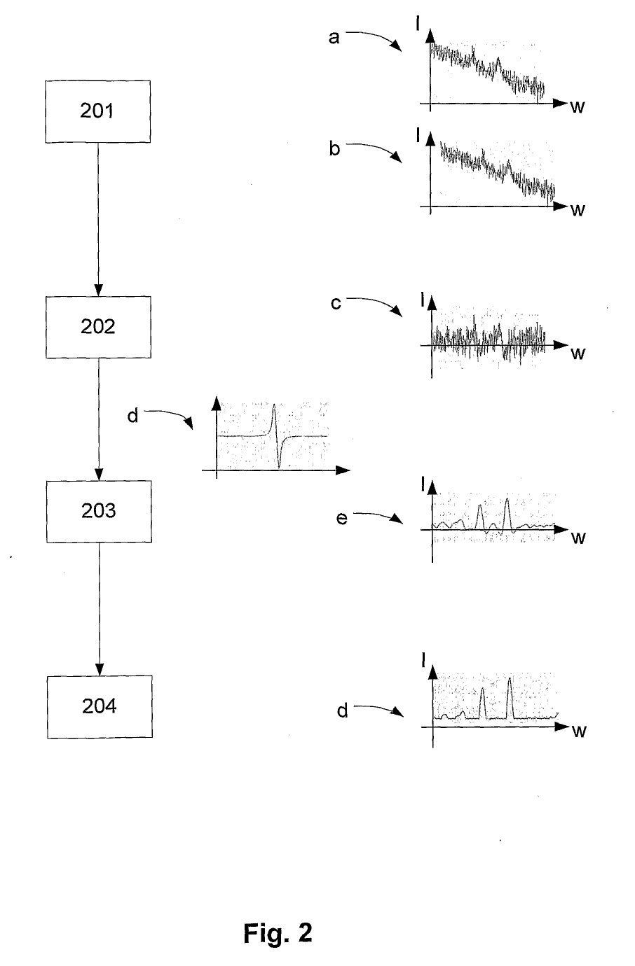

FIG. 2 illustrates a flow diagram of the principles of the Shifted subtracted Raman spectroscopy method (SSRS). First two Raman spectra (a, b) are measured (201) by for instance a spectrometer. The spectra show the intensity (I) of the light as a function of wavelength (w) (typically measured in cm⁻¹) and the second spectrum (b) is shifted compared to the first spectrum (a). Thereafter the two spectra (a, b) are subtracted (202) resulting in a subtracted spectra (c). The subtracted spectrum (c) is then correlated (203) with a correlation function (d). The correlation function is chosen based on knowledge of the Raman lines in the spectra and knowledge of the shift between the two measures spectra (a, b). The correlation function could for instance be a lorenz, gauss or a voigt function, depending on the spectrometers convolution of the signal and of the signal itself. The correlation function would then be mathematically shifted according to the optical shift of the signal. The resulting correlation (e) is finally (204) baseline corrected.

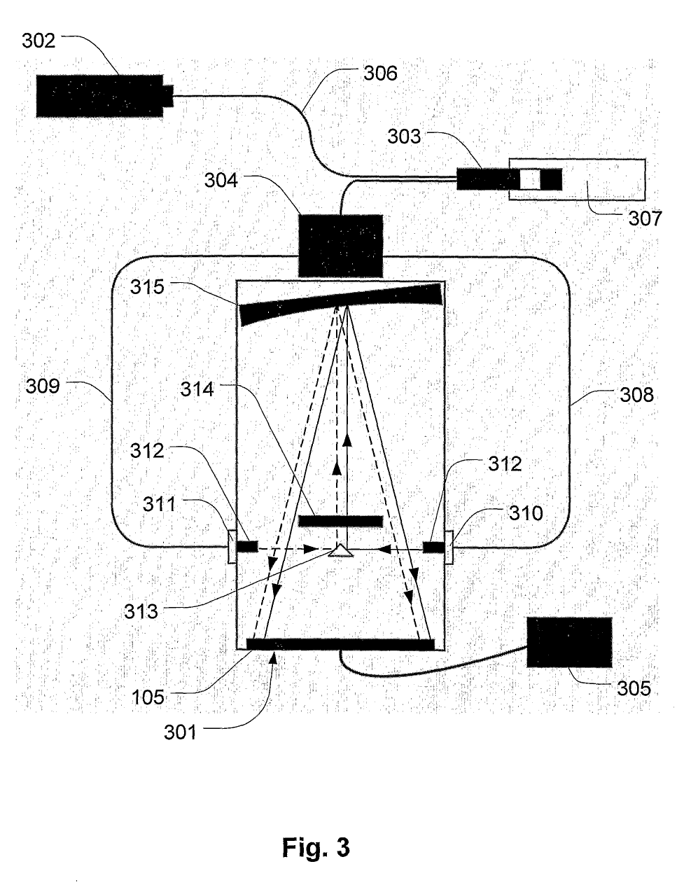

FIG. 3 illustrates an embodiment of the present invention where the spectrometer (301) according to the present invention is integrated in a probing system that uses the SSRS method in order to analyze Raman spectres. The probing system comprises a light source (302), a probe (303), an optical switch (304), a spectrometer (301) and data processing means (305). The light source (302) could for instance be a laser suitable for Raman spectroscopy such as helium-neon, argon-ion lasers. The light would be directed to a probe (303) e.g. through a number of optical fibres (306). The probe is in this embodiment adapted to illuminate a sample (307) and to collect backscattered light from the sample. However, the probe could be constructed in a number of different ways depending on sample, light source, its application etc. The light collected by the probe is directed to an optical switch (304) that can direct the light into a first (308) and a second optical path (309). The optical switch is able to adjust into which optical path the light is directed. The light from the first path enters the spectrometer at a first entry slit (310), and the light from the second path enters the spectrometer at a second entry slit (311).

The spectrometer comprises a first (310) and a second (311) entry slit, two collimation lenses (312), a prism (313), an optical filter (314), a concave reflection grating (315) and a CCD array (105).
The light in the first optical part travels inside an optical fibre and enters the spectrometer at the first entry (310). This could for instance be done by using a standard fibre coupler. The light from the optical fibre is then collimated using an optical lens e.g. a Gradient Index lens (GRIN). Thereafter the collimated light beam is directed to a prism (313), which reflects the collimated light beam trough an optical filter (314) and towards the concave reflection grating (315). The optical filter is designed to attenuate/remove the Rayleigh scattering from the sample, when the spectrometer is used in Raman spectroscopy. The concave reflection grating (315) disperses the light into wavelength segments and reflects and focuses the wavelength segments onto the CCD detector (105) such that each photo detector in the CCD array (105) detects a wavelength segment. The CCD detector can therefore measure the spectral distribution of the light from the first light path (308). The concave reflection grating is tilted in the vertical plane in order to avoid that the reflected and dispersed wavelength segments would hit the filter on their way towards the CCD detector. The result is that the CCD detector is placed a level above or under the filter and prism.

The light from the second optical path (309) would, just as the light from the first path, enter the spectrometer, be collimated, redirected by the prism, pass through the filer, be dispersed into wavelength segments, reflected and focused onto the CCD detector. However, the light would enter the spectrometer through the second entry slit (311) and therefore hit the opposite side of the prism. The consequence is that the collimated light beam would hit the concave reflection grating at another place than the light from the first optical path. The wavelength segments would due to the reflection distance on the sides of the prism and the concavity of the grating therefore be focused other places on the CCD compared to the light from the first optical path. Hereby the spectrum is shifted on the CCD (105), and the CCD would therefore measure a shifted spectre compared to the light from the first optical path. The CCD detector would therefore be able to measure two spectra which are shifted in relation to each other.

The CCD detector is in this embodiment coupled to data processing means (205) such as a computer, microprocessor or the like. The data processing means is able to control the CCD detector and the optical switch. Thereby it is possible to direct the light from the probe into the first optical path (308) and measure a spectre using the CCD detector; thereafter the data processing means is able to store/save the measured spectrum. Thereafter the optical switch directs the light from the probe into the second optical path (309), and the CCD detector would then measure a shifted spectrum, which is also stored/saved by the data processing means. The data processing means is adapted to perform the SSRS method (described above) using the two measured shifted spectra. The resulting spectrum from the SSRS method could thereafter for instance be used to analyze the molecular components of the sample.

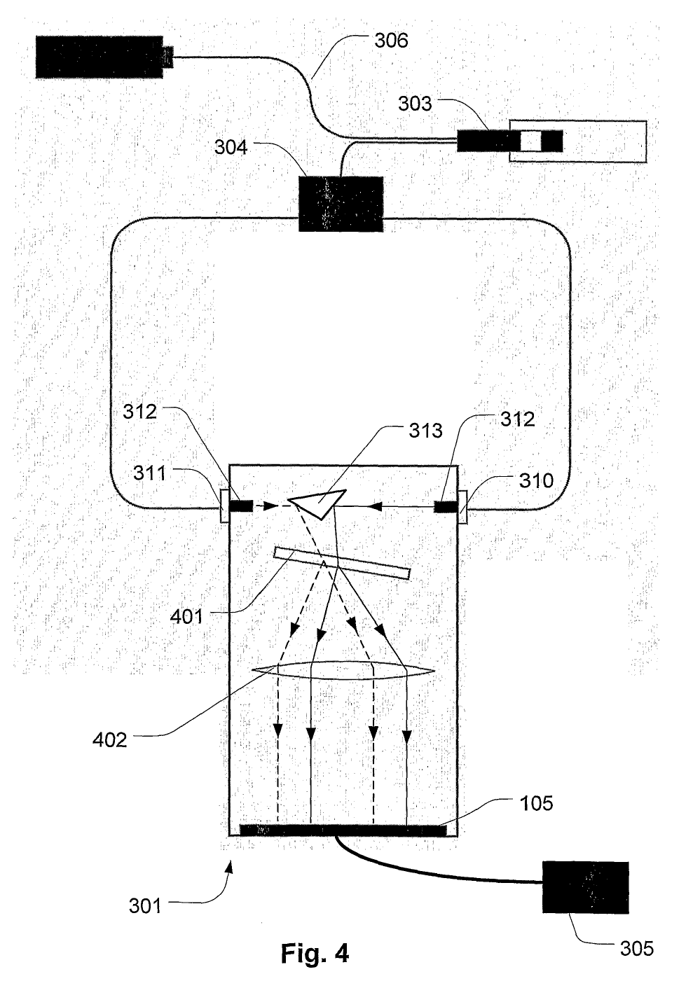

FIG. 4 illustrates another embodiment of the probing system illustrated in FIG. 3. The probing system comprises a light source (302), a probe (303), an optical switch (304), a spectrometer (301) and data processing means (305) like the probing system in FIG. 3. However, the spectra shift is achieved by using a transmission grating (401) instead of a concave grating. The two light beams pass through the transmission grating (401) after having been reflected by the prism (313). The transmission grating disperses the light into wavelength segments, and the wavelength segments are thereafter focused e.g. by an optical lens (402) onto the CCD detector, such that each wavelength segment is focused on the photo detector at the CCD detector. The shift is in this embodiment also achieved by the prism, such that the two light beams hit the prism on opposite sides and/or at different angles. The consequence is that the two light beams would hit the transmission grating at different distances and/or angles resulting in that the wavelength segments would hit the CCD detector at different places. Hereby a shift between the two spectra is achieved and the CCD could measure the two spectra.

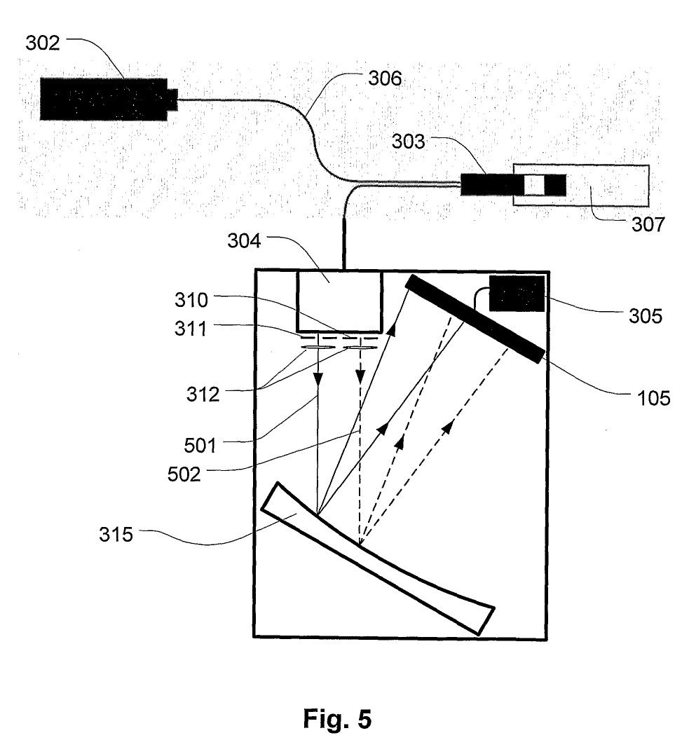

FIG. 5 illustrates another embodiment of the present invention. The optical switch (304) is in this embodiment integrated in the spectrometer. The optical switch is adapted to direct the light into two optical paths as illustrated with a solid line (501) and a dashed line (502). The two light beams pass the entry slits (310, 311) and are collimated by focusing means (312) and hit in this embodiment a concave reflection grating (315) that reflects, disperses and focuses the two light beams onto the CCD-detector. Hereby a shift in the two spectra is achieved as described above. Furthermore, a data processing means (305) for implementation of the SSRS method is integrated in the spectrometer.

The advantages of the above described systems are that the shift of the two spectra could be designed very precisely by a person skilled in the art. The consequence is that the reference function used to correlate with the subtracted shifted spectra in the SSRS method described in FIG. 2 could be chosen according to the optical properties of the spectrometer. The result is that an apparatus for measuring shifted spectra for use in an SSRS method could be constructed and used as a tool when analysing Raman spectra.

The above described embodiments merely serve as examples and should therefore not limit the scope of the present invention, since a person skilled in the art would be able to design similar systems inside the scope of invention.

1. A spectroscopic apparatus for measuring at least two spectrally shifted spectral distributions of a light beam, said apparatus comprising:
a dispersive element adapted to generate a spatial dispersion of the spectral components in a light beam when said dispersive element is being illuminated by said light beam;
a detector adapted to measure the intensity of at least a part of said dispersed spectral components;
characterized in that said apparatus further comprises:
optical shifting means adapted to illuminate said dispersive element in at least two different ways, whereby said dispersive element generates at least two spatially shifted spatial dispersions of the spectral components in said light beam.

2. A spectroscopic apparatus according to claim 1 characterized in that said optical shifting means comprises an optical switch, a first optical path and a second optical path, where said optical switch is adapted to receive said light beam and adapted to direct said light beam into said first optical path or into said second optical path, said first optical path being adapted to illuminate said dispersive element in a first way, whereby said dispersive element generates a first spatial dispersion of the spectral components in said light beam, and said second optical path being adapted to illuminate said dispersive element in a second way, whereby said dispersive element generates a second spatial dispersion of the spectral components in said light beam, said second dispersion being spatially shifted compared to said first spatial dispersion.

3. A spectroscopic apparatus according to claim 2 characterized in that said first optical path comprises a first slit illuminated by said light beam, first collimation means receiving said light beam from said first slit, where said first collimation means is adapted to collimate said light beam such that said dispersive element in said first way is illuminated by a first collimated light beam.

4. A spectroscopic apparatus according to claim 2 or claim 3 characterized in that said second optical path comprises a second slit illuminated by said light beam, second collimation means receiving said light beam from said second slit, where said second collimation means is adapted to collimate said light beam such that said dispersive element in said second way is illuminated by a second collimated light beam.

5. A spectroscopic apparatus according to any of the preceding claims 1-4 characterized in that said apparatus further comprises focusing means adapted to focus at least a part of said at least two spatially shifted spatial dispersions onto said detector.

6. A spectroscopic apparatus according to any of the preceding claims 1-5 characterized in that said detector is a detector comprising a number of photo detectors.

7. A spectroscopic apparatus according to claim 5 and claim 6 characterized in that said focusing means further is adapted to focus said at least a part of said two spatially shifted spatial dispersions onto a number of said photo detectors such that each photo detector is illuminated by different spectral components when said dispersive element is illuminated in different ways.

8. A probing system for analysing a light beam collected from a sample, characterized in that said probing system comprises a spectroscopic apparatus as described by claim 1-7.

9. A probing system according to claim 8 characterized in that said probing system further comprises a light source for illumination of said sample.

10. A probing system according to claim 9 or claim 10 characterized in that said probing system further comprises an optical probe adapted to collect a light beam from said sample and adapted to direct said light beam into said spectroscopic apparatus described by claim 1-7.

11. A probing system according to any of the preceding claims 8-10 characterized in that said probing system further comprises processing means and storing means, said processing being adapted to store spectrally shifted spectral distributions measured by said spectroscopic apparatus in said storing means.

12. A probing system according to any of the preceding claims 8-11 characterized in that said processing means further is adapted to perform a SSRS method using said spectrally shifted spectral distributions.

13. A method for measuring at least two spectrally shifted spectral distributions of a light beam; said method comprising the steps of:
generating a first spatial dispersion of the spectral components in said light beam by illuminating a dispersive element by said light beam in a first way, such that said dispersive element generates a first spatial dispersion of the spectral components in said light beam;
detecting the intensity of at least a part of said first spatial dispersion using a detector;
characterized in that said method further comprises the steps of:
generating a second spatial dispersion of the spectral components in said light beam by illuminating said dispersive element by said light beam in a second way, such that said dispersive element generates a second spatial dispersion of the spectral components in said light beam, said second dispersion being spatially shifted compared to said first spatial dispersion;
detecting the intensity of at least a part of said second spatial dispersion using said detector.
